(19) United States
(12) Patent Application Publication
(10) Pub. No.: US 2009/0291177 A1
(43) Pub. Date: Nov. 26, 2009

(54) Method of Lowering the Redox Potential of a Liquid by Injection of a Gas While Preventing Foaming

(75) Inventors: Simon Jallais, Chaville (FR); Dominique Ibarra, Gif-Sur-Yvette (FR)

Correspondence Address: AIR LIQUIDE;Intellectual Property, 2700 POST OAK BOULEVARD, SUITE 1800, HOUSTON, TX, 77056, US

(73) Assignee: L'Air Liquide Societe Anonyme Pour L-Etude Et L'Exploitation Des Procedes Georges Claude, Paris (FR)

(21) Appl. No.: 12/307,894

(22) PCT Filed: Jun. 28, 2007
(86) PCT No.: PCT/FR2007/051546

§ 371 Date: Jan. 7, 2009

(30) Foreign Application Priority Data
Jul. 7, 2006 (EP) 06300774.4

(51) Int. Cl. A23C 3/037

(52) U.S. Cl. 426/474

(57) ABSTRACT

According to the invention the liquid to be treated is contacted with the gas mixture in a column which is traversed simultaneously by each of the two fluids.

The invention relates to the field of the treatment of liquid foodstuffs with the aid of gaseous mixtures.

As an illustration, work carried out by the Applicant has shown that it may be of value to inject gaseous mixtures based on an inert gas or furthermore based on a reducing gas such as hydrogen into various liquid media, notably foodstuffs, in order to reduce the redox potential. Mention may be made of the following examples:
Injection into a finished product such as for example orange juice or any fruit juice. In this way, it is possible to improve the keeping properties of the product by combating oxidation reactions (limitation of browning, preservation of vitamin C etc.).
Injection into intermediate liquid products during the manufacturing process. It is possible for example to inject the gaseous mixture into milk, enriched or not with proteins, which serves as a base for the manufacture of yoghurts, cheeses and other dairy products. The sensory properties of the product are modified by this (flavors, texture etc.)
Injection into a fermentation medium intended for the production of biomass or valuable molecules. The physiology and metabolism of microorganisms may be controlled in this way.

Now, one is often bound to find that direct injection of gas into the liquid (bubbling) presents serious foaming problems. This is for example the case for orange juice and tea-based beverages, as well as milk. The presence of proteins in the medium is in all probability responsible for part of the phenomenon.

Now, it should be known that this severe foaming problem brings about many inconveniences such as in particular loss of material and packaging difficulties as well as clogging of the production installation.

It may be pointed out that the existing literature proposes a certain number of solutions to the technical problem referred to above.

One of the solutions currently proposed to prevent foam formation during manufacture of food products or indeed in fermenters (during stirring for example) is to add anti-foam agents, such as for example polyethyleneglycol or polysorbates (E 432 to E436), so as to reduce the surface tension. This addition of additives has several disadvantages. It should in particular appear on the labeling of the finished product although it presents the consumer with a negative unnatural image of the product. Moreover, these additives are not always sensorily neutral. Finally they are sometimes quite simply prohibited in some products by the legislation. Thus, for example European legislation does not authorize the use of additives other than ascorbic acid (E300) or citric acid (E330) in fruit juices.

Other solutions may be used, such as for example mechanical action or pressure in order to break the foam that forms in a vessel, but these techniques do not make it possible to treat a liquid continuously and find their limit within the context of liquids to be treated that are particularly foaming.

A real need therefore has been found to be able to have available an improved solution for the gaseous treatment of liquid foodstuffs with a view to reducing the redox potential thereof, that does not bring about foam formation, that is sensorily neutral and is acceptable in terms of the legislation. For such a solution to be satisfactory it should of course permit continuous treatment alone compatible with industrial application.

It is then desired to provide, according to the present invention, an apparatus enabling such a liquid to be exposed to a gaseous mixture continuously by tackling foaming phenomena in order to improve the sensory qualities of the liquid treated in this way. Another of the objectives of the present invention is to provide an apparatus that will permit optimized injection, reducing the consumption of gas associated with the treatment.

As will be seen in greater detail hereinafter, the invention proposes to change the exchange surface between the gas and liquid compared with that which is traditionally produced during conventional bubbling.

To this end, exchange between the gas and liquid to be treated is carried out in a column through which the gas and liquid pass, according to various configurations that may be envisaged, among which:
passage of the two fluids may take place in the column concurrently or counter-currently.

As an example, the liquid is injected at the top of the column and flows downwards by gravity, whereas the gas mixture is injected at the bottom of the column and rises counter-currently to the flow of liquid.
the column may be filled with a material (for example a structured packing or even a random packing such as rings, beads, cylinders or other geometrical forms the size of which will be determined according to the dimensions of the column) or it may be empty of any material and exchange then occurs either at the surface of the droplets of liquid falling in a fine rain in a column, or at the surface of the film flowing downwards by gravity along the walls of the column while the active gas is injected at the bottom of the column and flows counter-currently upwards inside the tube.

It should be noted that although it is possible to treat a liquid in its entirety with the column, it would also be possible to implement the invention by treating all or part of the constituents of the liquid in the column separately. Thus, in the case of fruit juices, it will for example be possible to treat only water entering into the composition or to treat water according to the invention but also the concentrate separately, and optionally to add pulp subsequently.

According to one of the advantageous embodiments of the invention, a system for recycling liquid is put into practice (loop on the liquid) in order to obtain very low values for the redox potential of the treated liquid.

The liquid is then recovered at the bottom of the column and re-injected at the inlet to the column in order to undergo treatment once again. This principle makes it possible to increase the treatment capacity, taking into account the variability of the product to be treated (initial redox value, viscosity etc).

According to other advantageous embodiments of the invention, in order to limit gas consumption, it is proposed to associate, with the method for continuous treatment of the liquid, a recycling system and/or separation of gases that may comprise the following elements:
A gas supercharger (that may be a compressor or a fan) enabling recirculation of the active gas to be created between the outlet and inlet of the treatment column.
Since oxygen may accumulate in the loop, it is proposed to associate therewith a catalytic de-oxygenation system for the recirculated active gas (for example of the DEOXO type based on combustion with interfering oxygen in the presence of hydrogen catalyzed by noble metals).
Since other compounds harmful to the treatment may accumulate in the recirculation loop, it is proposed to add thereto a polymeric membrane for gas separation. In the case of the use of hydrogen, since hydrogen has a permeability greater than other potentially gaseous compounds present in the recycling flow, it is separated on the permeate side with a high purity. This may then be mixed with an inert carrier gas (N₂, Ar, He, CO₂ etc. or a mixture of these gases) in order to maintain an acceptable hydrogen content (that is to say less than the lower flammability limit of hydrogen in air) at the inlet to the process for the continuous treatment of liquid. Since the adsorption force for hydrogen is typically lower than that for other compounds present in the recycling flow, hydrogen could also be separated by adsorption.

Other features and advantages of the invention will become apparent on reading the following description. Forms and embodiments of the invention are given by way of non-limiting examples, illustrated by the appended drawings in which:

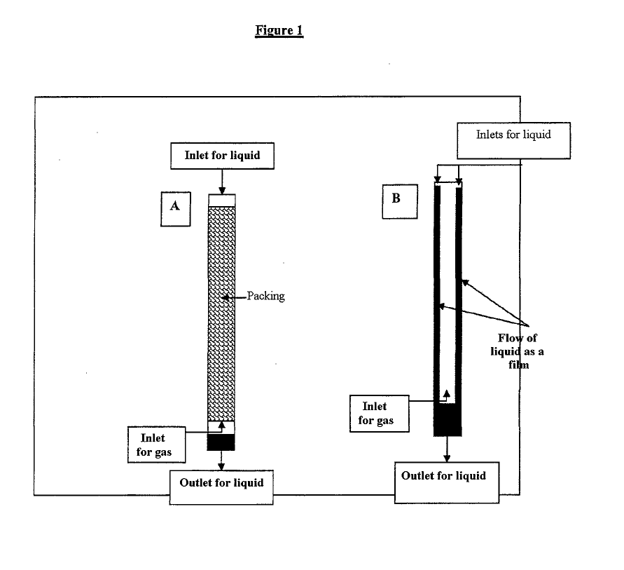

FIG. 1 provides two examples of columns suitable for implementing the invention (respectively full and empty of any material)

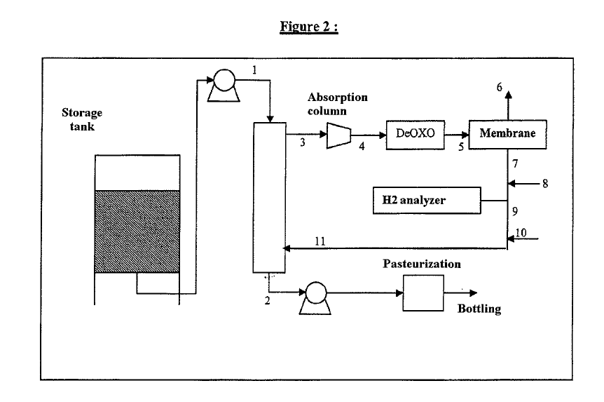

FIG. 2 provides an example of an installation for implementing the invention for treating orange juice and incorporating gas recycling.

The left hand part of FIG. 1 (“A”) illustrates the case of a column filled with a structured packing (packing from Sulzer, ref. 2118458 ALDX-Wo5 186C, stainless steel 316L) in which the two fluids are circulated counter-currently and the liquid to be treated (for example an orange juice) passes downward.

The passage of the two fluids may take place in the column concurrently or counter-currently, and as an example for the method of FIG. 1A, the liquid is injected at the top of the column and flows downward by gravity, while the gas mixture is injected at the bottom of the column and rises counter-currently to the flow of liquid.

The column may be full of a material (for example a structured or even a random packing such as rings, beads, cylinders or other small geometric forms) or it may be empty of any material and liquid/gas exchange occurs by the flow of liquid in a film downwards by gravity along the walls of the column while the active gas is injected at the bottom of the column and flows counter-currently upward inside the tube, or again at the surface of droplets falling in a fine rain in the column.

The results will be described hereinafter of a first example of an embodiment of the invention on orange juice.

Orange juice is in point of fact an enormously foaming medium when it is swept by a gas according to traditionally used means (sweeping with the aid of a sinter) even at a low gas flow (for example 0.03 gas volume per liquid volume and per minute).

A glass laboratory column was used here of which the interior was equipped with glass elements in the form of a spring (of the “pigtail” or “corkscrew” type).

The treatment gaseous mixture used was as follows: N₂/H₂ (96%-4%).

The initial redox potential (Eh) of the orange juice was 215 mV.

The orange juice was contacted with the gaseous mixture in the column counter-currently.

Under such practical conditions, it was possible to reduce the redox potential of the orange juice to values of approximately −300 mV without the formation of foam (see Table 1 below), which is absolutely impossible according to traditional injection with the aid of a sinter.

TABLE 1
Results of modifying the redox potential of
an orange juice according to example 1.

| Gas flow | Max. orange juice | |
|---|---|---|
| rate (ml/min) | flow rate (min) | Final Eh (mV) |
| 142 | 162 | −270 |
| 340 | 112 | −327 |

It may be thought that, by virtue of implementing the invention, the liquid is contacted with the gas in the form of a film. There is therefore no intrusion of gas bubbles into the liquid to be treated.

FIG. 2 provides an example of an installation for implementing the invention for treating orange juice and incorporating gas recycling.

Orange juice contained in a storage tank is pumped to the liquid-gas absorption column operating here counter-currently. The flow 1 containing orange juice (naturally oxygenated) is treated in the column by the gas flow 11 (4% H₂—96% N₂) and leaves (2) at the bottom of the column treated in this way and in particular deoxygenated.

The gas (10) leaves at the top of the column (3) and is then compressed to a pressure below 5 bar (4). This flow 4 is treated by a deoxygenation reactor, making it possible to eliminate gaseous oxygen desorbed within the column from this gas mixture, deoxygenation being according to the reaction H₂+½O₂→H₂O.

The flow 5, free from oxygen, is treated by a polymeric membrane enabling a flow 7 to be obtained containing substantially hydrogen and a flow 6 containing the purge gas of the process.

“Fresh” nitrogen (flow 8), preferably coming from a cryogenic storage installation, is added to the flow 7 in order to bring the hydrogen content of the flow to 4%.

In order to avoid reductions in the gas flow to be treated, a flow 10 containing a H₂—N₂ mixture is added to the flow 9 to form the flow 11 containing H₂ (4%)—N₂ (QS).

A description is given hereinafter concerning a second example of an embodiment.

Five liquids (water, concentrate-based orange juice, pure orange juice, concentrate-based grapefruit juice and a tea-based beverage) were treated with a column according to the invention under the following conditions:
a bulk packing of the Raschig ring type made of stainless steel 316,
liquid flow rate: 200 l/h
passage of an N₂/H₂ (96/4) mixture in the column in counter-current; gas/liquid ratio of 1/1.

The redox values (Ehm), measured with the aid of a Mettler Toledo probe before and after treatment according to the invention, are given in table 2 below.

Under such implementing conditions, it was possible to lower the redox potential of liquids treated to the desired redox potential values, without forming a foam, which is still not absolutely possible according to traditional injection with a sinter.

TABLE 2
Results of modifying the redox potential of various liquids.

| Liquid to be treated | Initial Ehm | Final Ehm |
|---|---|---|
| Water | +310 mV | −450 mV |
| Concentrate-based | +230 mV | −385 mV |
| orange juice | | |
| Pure orange juice | +235 mV | −360 mV |
| Concentrate-base | +250 mV | −350 mV |
| grapefruit juice | | |
| Tea-based beverage | +370 mV | −350 mV |

1-13. (canceled)

14. A method for the treatment of a liquid foodstuff with the aid of gaseous mixture aimed at injecting the gaseous mixture into the liquid so as to reduce the redox potential while preventing the foaming phenomenon, characterized in that the liquid to be treated is contacted with the gaseous mixture in a column through which each of the gaseous mixture and liquid passes simultaneously.

15. The method for the treatment of a liquid foodstuff of claim 14, wherein the liquid and gaseous mixture pass through the column concurrently.

16. The method for the treatment of a liquid foodstuff of claim 14, wherein the liquid and gaseous mixture pass through the column counter-currently.

17. The method for the treatment of a liquid foodstuff of claim 14, wherein the column is empty of any material and in that liquid/gas exchange occurs according to one or more of the following methods: at a surface of droplets of liquid falling in a rain in the column, and by a downward flow of liquid under gravity along walls of the column while the gaseous mixture is injected at a bottom of the column and flows counter-currently upwards inside the column.

18. The method for the treatment of a liquid foodstuff of claim 14, wherein the column is at least partially full of a structured or random packing material and in that liquid/gas exchange occurs within the packing.

19. The method for the treatment of a liquid foodstuff of claim 14, wherein the liquid foodstuff treated is a fruit juice.

20. The method for the treatment of a liquid foodstuff of claim 14, wherein the liquid foodstuff treated in water, entering into the composition of a fruit juice.

21. The method for the treatment of a liquid foodstuff of claim 14, wherein the gaseous mixture is hydrogen or a mixture of gases including hydrogen.

22. The method for the treatment of a liquid foodstuff of claim 14, wherein the gaseous mixture is a mixture of hydrogen and carbon dioxide.

23. The method for the treatment of a liquid foodstuff of claim 14, wherein the gaseous treatment mixture comprises hydrogen and a complementary gas that is acceptable from the point of view of said liquid to be treated.

24. The method for the treatment of a liquid foodstuff of claim 23, wherein the complementary gas is an inert gas selected from the group consisting of argon, helium, carbon dioxide, nitrous oxide, and mixtures thereof.

25. The method for the treatment of a liquid foodstuff of claim 14, wherein the value of the redox potential reached after treatment is negative.

26. The method for the treatment of a liquid foodstuff of claim 14, wherein the value of the redox potential reached after treatment is lower by at least 100 mV than the initial value of the liquid before treatment.
